(19) United States
(12) Patent Application Publication
(10) Pub. No.: US 2009/0317706 A1
(43) Pub. Date: Dec. 24, 2009

(54) Lithium Polymer Battery

(76) Inventor: Yu-Ta Tu, Taipei City (TW)

Correspondence Address: David Shung, P.O. Box 10557, Taipei, 100, TW

(21) Appl. No.: 12/486,053

(22) Filed: Jun. 17, 2009

(30) Foreign Application Priority Data
Jun. 20, 2008 (TW) 097210899

(51) Int. Cl. H01M 6/12

(52) U.S. Cl. 429/162

(57) ABSTRACT

An improvement of lithium polymer secondary battery is disclosed. The Li-polymer battery is composed of an anode sheet, a cathode sheet and a separator film sandwiched therebetween. The anode sheet includes a positive collector and a pulp coated thereon, which is formed by positive material, conductive material, glue and solvent. The cathode sheet includes a negative collector and a pulp coated thereon, which is formed by negative material, conductive material, glue and solvent. The separator film includes glue and solvent for adhering between the anode sheet and cathode sheet. The anode and cathode sheet are provided with holes uniformly arranged. The holes are formed by using a knife to penetrate the sheets. The holes make the electrolyte easy to permeate through so that the internal resistance of battery can be reduced.

### BACKGROUND OF THE INVENTION

1. Field of the Invention

The invention generally relates to rechargeable lithium batteries, more particularly to lithium polymer batteries.

2. Related Art

With fast development of portable consumer electronic apparatuses such as cellular phones, laptop computers and personal digital assistants (PDAs), secondary batteries with lighter weight, higher performance and lower cost than ever are imperiously required by markets. Lithium polymer batteries are the best among all kinds of the secondary batteries because of their advantages of high energy density, long cycle durability, high operating voltage, long time durability and safety.

A conventional lithium polymer battery, as shown in FIG. 1, includes an anode sheet 10, a cathode sheet 11 and a separator film 12 sandwiched therebetween. The separator film 12 is used for isolating and bonding the anode and cathode sheet 10, 11 together to form a cell unit 1. Referring to FIG. 2, the cell unit 1 with two leads 13, 14 is put in an aluminum foil bag (not shown) for dewatering, and then an electrolyte is filled into the bag to have the cell unit 1 activate. However, the electrolyte is hard to permeate through the inside of the anode and cathode sheet 10, 11. The internal resistance of battery is overhigh easily and the performance of battery is not good enough.

### SUMMARY OF THE INVENTION

The invention provides an improved lithium polymer battery (Li-polymer). The Li-polymer battery is composed of an anode sheet, a cathode sheet and a separator film sandwiched therebetween. The anode sheet includes a positive collector and a pulp coated thereon, which is formed by positive material, conductive material, glue and solvent. The cathode sheet includes a negative collector and a pulp coated thereon, which is formed by negative material, conductive material, glue and solvent. The separator film includes glue and solvent for adhering between the anode sheet and cathode sheet. The anode and cathode sheet is provided with holes uniformly arranged. The holes are formed by using a knife to penetrate the sheets.

Thus, an object of the invention is to make the electrolyte easy to permeate through the anode and cathode sheet by the holes so that the internal resistance of battery can be reduced and the performance of battery can be improved.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view of a conventional lithium polymer battery;

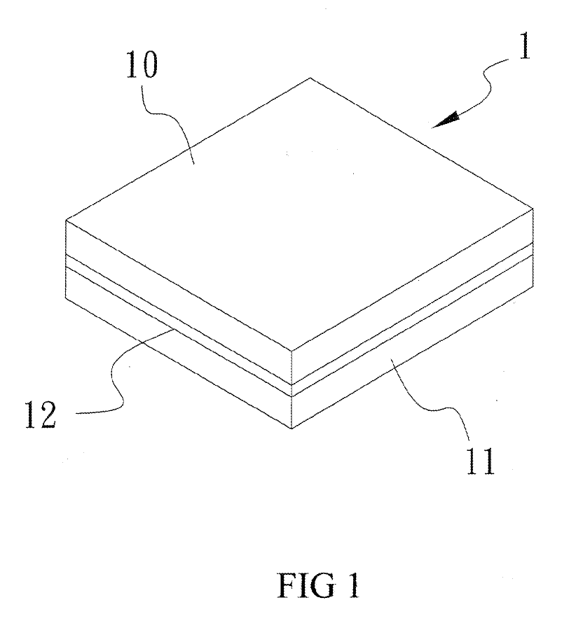

FIG. 2 illustrates the conventional battery adding two electrode leads;

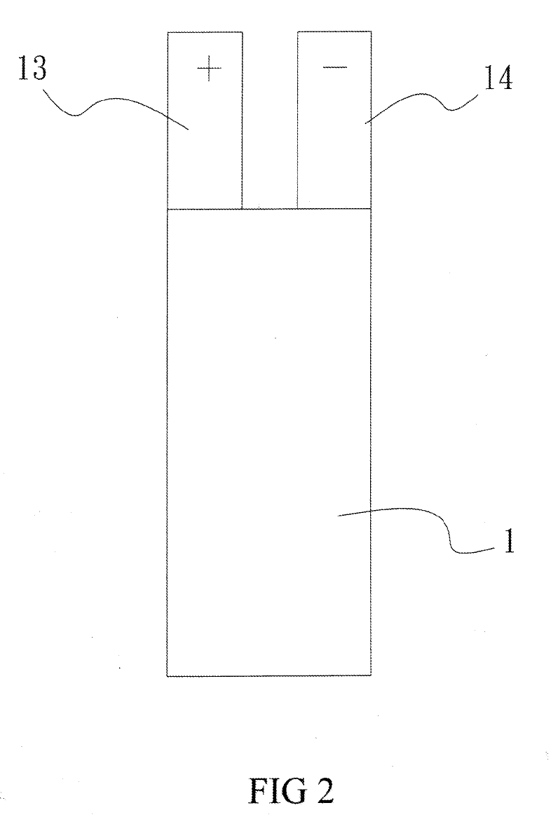

FIG. 3 is a perspective view of a lithium polymer battery of the invention;

FIG. 4 illustrates how the anode sheet forms;

FIG. 5 illustrates how the cathode sheet forms;

FIG. 6 illustrates the anode sheet having holes; and

FIG. 7 illustrates the cathode sheet having holes.

### DETAILED DESCRIPTION OF THE INVENTION

Hereinafter, a preferred embodiment of the present invention will be described with reference to the accompanying drawings. In the following description of the present invention, a detailed description of known functions and configurations incorporated herein will be omitted when it may make the subject matter of the present invention rather unclear.

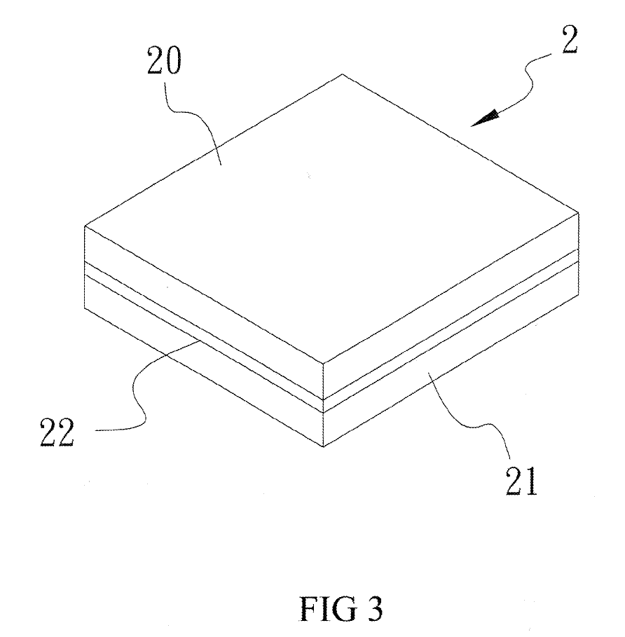

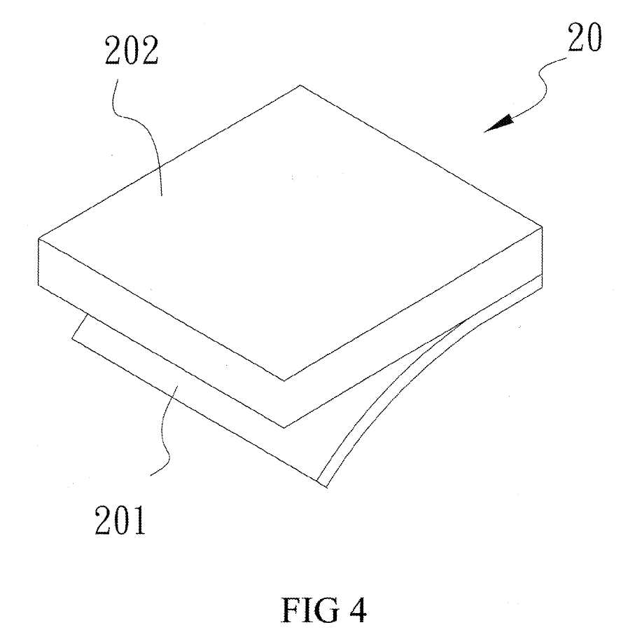

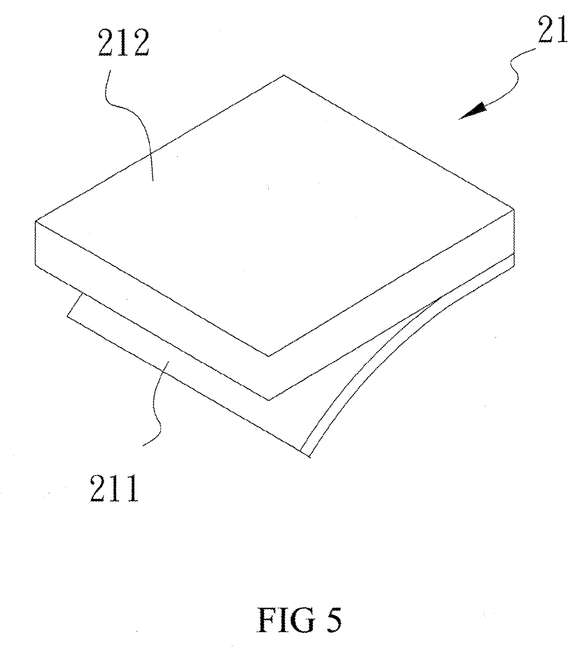

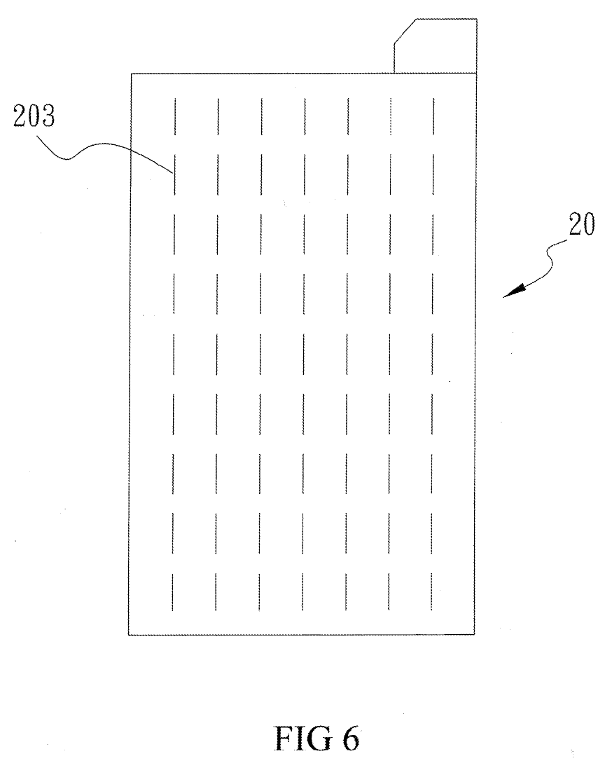

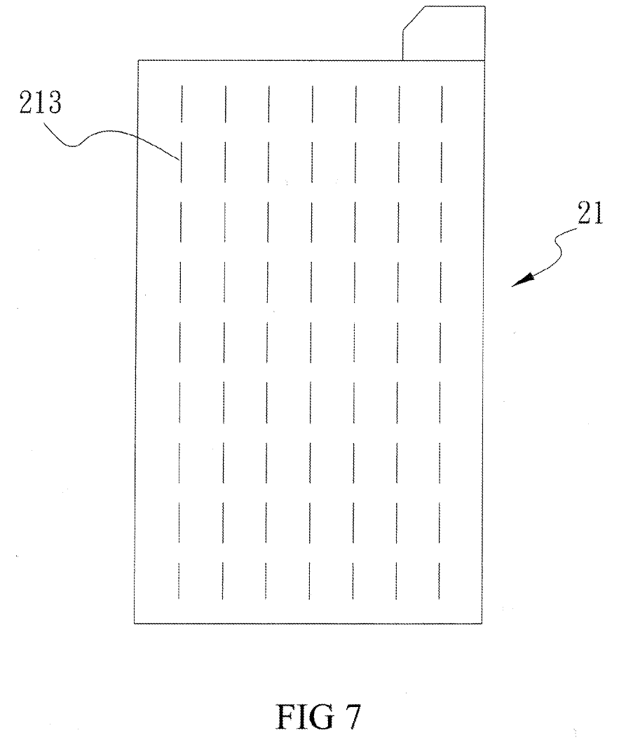

As can be seen in FIG. 3, a lithium polymer batter of the invention includes an anode sheet 20, a cathode sheet 21 and a separator film 22 sandwiched therebetween. Further referring to FIG. 4, the anode sheet 20 includes a positive collector 202 and a positive pulp 201 coated thereon. The positive pulp 201 is formed by mixing positive material, conductive material, glue and solvent. The positive pulp 201 smeared on the positive collector 202 is shaped into a sheet by drying and pressing. Referring to FIG. 5, the cathode sheet 21 includes a negative collector 212 and a positive pulp 211 coated thereon. The negative pulp 211 is formed by mixing negative material, conductive material, glue and solvent. The negative pulp 211 smeared on the negative collector 212 is shaped into a sheet by drying and pressing. The separator film 22 includes glue and solvent for adhering between the anode sheet 20 and cathode sheet 21. Thus a cell unit 2 can be obtained. As shown in FIGS. 6 and 7, after the anode and cathode sheet 20, 21 have been formed, the anode and cathode sheet are provided with holes 203, 213 uniformly arranged. The holes 203, 213 are formed by using a knife to penetrate the sheets 20, 21. The holes 203, 213 make the electrolyte easy to flow and fast permeate through so that the internal resistance of battery can be reduced and the performance of battery can be improved.

While the invention has been shown and described with reference to a preferred embodiment thereof, it will be understood by those skilled in the art that various changes in form and details may be made therein without departing from the spirit and scope of the invention as defined by the appended claims.

What is claimed is:

1. A lithium polymer battery comprising:
an anode sheet;
a cathode sheet; and
a separator film sandwiched between the anode sheet and the cathode sheet;
wherein both the anode sheet and the cathode sheet are provided with a plurality of holes for being flowed through.

2. The lithium polymer battery of claim 1, wherein the anode sheet includes a positive collector and a positive pulp coated thereon, the positive pulp is formed by positive material, conductive material, glue and solvent; wherein the cathode sheet includes a negative collector and a negative pulp coated thereon, the negative pulp is formed by negative material, conductive material, glue and solvent; and the separator film includes glue and solvent for adhering between the anode sheet and cathode sheet.
